(19) United States
(12) Patent Application Publication
(10) Pub. No.: US 2025/0235951 A1
(43) Pub. Date: Jul. 24, 2025

(54) LASER SYSTEM AND METHOD FOR LASER MACHINING A WORKPIECE

(71) Applicant: TRUMPF Laser GmbH, Schramberg (DE)

(72) Inventor: Daniel Flamm, Ludwigsburg (DE)

(21) Appl. No.: 19/062,084

(22) Filed: Feb. 25, 2025

Related U.S. Application Data
(63) Continuation of application No. PCT/EP2023/072154, filed on Aug. 10, 2023.

(30) Foreign Application Priority Data
Aug. 26, 2022 (DE) 10 2022 121 616.0

(51) Int. Cl. B23K 26/06; B23K 26/064; B23K 26/073; B23K 26/36

(52) U.S. Cl. CPC B23K 26/0604; B23K 26/064; B23K 26/0665; B23K 26/073; B23K 26/36

(57) ABSTRACT

A laser system for laser machining a workpiece using an interference pattern includes at least one laser beam source for providing a plurality of coherent laser beams, an amplification device for forming amplified coherent laser beams by amplifying the plurality of coherent laser beams, a phase adjustment device for adjusting a phase difference between the plurality of coherent laser beams and/or the amplified coherent laser beams, and a beam convergence region in which output laser beams based on the amplified coherent laser beams or corresponding to the amplified coherent laser beams converge to form the interference pattern. At least beam portions of the different output laser beams converge in the beam convergence region.

### CROSS REFERENCE TO RELATED APPLICATIONS

This application is a continuation of International Application No. PCT/EP2023/072154 (WO 2024/041903 A1), filed on Aug. 10, 2023, and claims benefit to German Patent Application No. DE 10 2022 121 616.0, filed on Aug. 26, 2022. The aforementioned applications are hereby incorporated by reference herein.

### FIELD

Embodiments of the present invention relate to a laser system and a method for laser machining a workpiece using an interference pattern.

### BACKGROUND

DE 10 2008 037 042 A1 discloses an apparatus for shaping a laser beam, comprising symmetrizing means which can interact with the laser beam to be shaped in such a way that after the interaction at least two sections or partial beams of the laser beam which are different in the transverse direction of the laser beam are spatially coherent with each other at least at points or in regions, and superposition means for superpositioning the at least two sections or partial beams with each other, wherein the superposition means are arranged in the beam path of the laser beam downstream of the symmetrizing means.

DE 10 2018 105 254 B4 discloses a method for machining an object by means of interfering laser beams, wherein a collimated laser beam is generated, the intensity distribution and/or the phase progression over the cross section of the laser beam is influenced, the laser beam is split into two partial beams, and the partial beams are deflected and focused so that the partial beams are superpositioned in a machining zone in the material of the object, the deflection and focusing of the partial beams comprising an aberration correction.

### SUMMARY

Embodiments of the present invention provide a laser system for laser machining a workpiece using an interference pattern. The laser system includes at least one laser beam source for providing a plurality of coherent laser beams, an amplification device for forming amplified coherent laser beams by amplifying the plurality of coherent laser beams, a phase adjustment device for adjusting a phase difference between the plurality of coherent laser beams and/or the amplified coherent laser beams, and a beam convergence region in which output laser beams based on the amplified coherent laser beams or corresponding to the amplified coherent laser beams converge to form the interference pattern. At least beam portions of the different output laser beams converge in the beam convergence region.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an exemplary embodiment of a laser system, in which a beam path is indicated in a first cross-sectional plane;

FIG. 2 shows a schematic representation of a portion of the laser system according to FIG. 1, in which a beam path is indicated in a second cross-sectional plane oriented perpendicular to the first cross-sectional plane;

FIG. 3 shows a schematic representation of a portion of an embodiment of the laser system with a focusing element for collimating and deflecting amplified coherent laser beams;

FIG. 4 shows a schematic representation of a portion of an embodiment of the laser system with a plurality of focusing elements for collimating the amplified coherent laser beams and a beam deflection device for deflecting them;

FIG. 5 shows a schematic representation of a portion of another embodiment of the laser system with a plurality of focusing elements;

FIG. 6 shows a schematic representation of a portion of an embodiment of the laser system without focusing elements;

FIG. 7 shows a schematic representation of a portion of another embodiment of the laser system without focusing elements;

FIG. 8a, FIG. 8b and FIG. 8c show grayscale representations of an example of an interference pattern intended for laser machining of a workpiece at different scales, according to some embodiments;

FIG. 9a, FIG. 9b and FIG. 9c show grayscale representations of another example of an interference pattern intended for laser machining of a workpiece at different scales, according to some embodiments; and

FIG. 10 shows a grayscale representation of another example of an interference pattern intended for laser machining of a workpiece, according to some embodiments.

### DETAILED DESCRIPTION

Embodiments of the invention provide a laser system and a method which are flexible and versatile and enable a high degree of control of the properties of the interference pattern intended for laser machining of the workpiece.

According to embodiments of the invention, the laser system comprises at least one laser beam source for providing a plurality of coherent laser beams, an amplification device for forming amplified coherent laser beams by amplifying the coherent laser beams, a phase adjustment device for adjusting a phase difference between the coherent laser beams and a beam convergence region in which output laser beams based on the amplified coherent laser beams or corresponding to the amplified coherent laser beams converge to form the interference pattern, wherein at least beam portions of different and/or adjacent output laser beams converge in the beam convergence region.

Using the laser system and the interference pattern formed, laser machining of the workpiece can be carried out according to the principle of direct laser interference patterning (DLIP).

For example, laser machining of the workpiece is carried out using the provided interference pattern in the region of its outer side and/or surface. The interference pattern is applied to the outer side or surface for laser machining in order to create surface material modifications with predetermined properties. For example, by applying the interference pattern to the outer side of the workpiece, material can be removed or depressions or ‘dimple-like’ structures can be created.

Using the laser system according to embodiments of the invention, for example, workpieces can be machined which are formed from or comprise a glass material and/or plastic material and/or metallic material.

The laser system according to embodiments of the invention makes it possible, for example, to split an input laser beam provided by the laser beam source into a plurality of coherent laser beams and then to amplify the coherent laser beams and, in particular, to amplify them spatially separately from one another. The coherent laser beams can be amplified, for example, using separate amplification elements. This enables spatially flexible positioning and orientation of the amplified coherent laser beams which are the basis for forming the output laser beams.

The fact that at least beam portions of the different and/or adjacent output laser beams converge means that the different output laser beams or portions of the different output laser beams converge and/or run towards one another to form the interference pattern. More precisely, Poynting vectors associated with the different output laser beams or the portions of the different output laser beams converge.

A coherent laser beam and/or amplified coherent laser beam and/or output laser beam is in particular in the form of a beam bundle and/or a sum of partial beams with a certain spatial extension. In particular, this beam bundle or these partial beams is associated in each case with a Poynting vector with a specific direction or several Poynting vectors with different directions.

Different output laser beams are to be understood in particular as output laser beams which are formed and/or result from different and/or adjacent amplified coherent laser beams.

In particular, it is possible for the phase adjustment device and the amplification device and/or a splitting device of the laser system to be designed as separate components of the laser system.

In particular, the coherent laser beams and/or the amplified coherent laser beams within the laser system are guided at least in sections in optical waveguides and in particular single-core waveguides. In particular, the coherent laser beams are guided between the splitting device and the phase adjustment device and/or between the phase adjustment device and the amplification elements in optical waveguides and in particular single-core waveguides. This in particular enables flexible positioning and/or orientation of the amplified coherent laser beams and/or the output laser beams.

In particular, it is possible for the adjacent output laser beams present in the beam convergence region to have at least beam portions which form an angle of at least 0.2° and/or at most 40° and preferably of at least 1° and/or at most 5°. This makes it possible to form the interference pattern easily from a technical standpoint.

Adjacent output laser beams are to be understood as output laser beams immediately adjacent to one another and/or output laser beams that are closest to one another and/or output beams that are closest neighbors to one another. In particular, no further output laser beams are arranged between adjacent output laser beams.

In particular, it is possible that, in the beam convergence region, output laser beams adjacent to one another have beam portions which form a non-vanishing first angle associated with a first angular coordinate, wherein the first angle is at least 0.2° and/or at most 40° and preferably at least 1° and/or at most 5°. This makes it possible, for example, to create the interference pattern in two dimensions.

It is possible that, in the beam convergence region, output laser beams adjacent to one another have beam portions which form a non-vanishing second angle associated with a second angular coordinate different from the first angular coordinate, wherein the second angle is at least 0.2° and/or at most 40° and preferably at least 1° and/or at most 5°. In this case, in the beam convergence region there are in particular both adjacent output laser beams which form the non-vanishing first angle with respect to one another and output laser beams which form the non-vanishing second angle with respect to one another.

The fact that beam portions of adjacent output laser beams form a non-vanishing angle with respect to one another is to be understood as meaning that at least beam portions of the adjacent output laser beams are associated with Poynting vectors which form the aforementioned non-vanishing first angle or second angle with respect to one another.

The first angle extends in a first direction and/or with respect to a first angular coordinate. The second angle extends in particular in a second direction and/or with respect to a second angular coordinate (relative to a specific output laser beam from which the first angle or the second angle is measured in relation to the adjacent output laser beams). This second direction or second angular coordinate is different from the first direction or first angular coordinate of the first angle α. In particular, the first direction or first angular coordinate is oriented transverse or perpendicular to the second direction or second angular coordinate.

When describing an orientation of the output laser beams in spherical coordinates, for example, the first angle corresponds to the polar angle and the second angle β corresponds to the azimuth angle.

In particular, it is possible for adjacent output laser beams present in the beam convergence region and in particular all adjacent output laser beams present in the beam convergence region to be oriented with respect to one another in such a way that two adjacent output laser beams each have either beam portions which form a non-vanishing first angle or beam portions which form a non-vanishing second angle. In particular, two adjacent output laser beams which form a non-vanishing first angle then each have a vanishing second angle, or vice versa. This can be achieved, for example, by directing a two-dimensional array of amplified coherent laser beams onto a focusing device to form the output laser beams.

In particular, it is possible for the output laser beams in the beam convergence region to be present as collimated beam bundles and/or plane waves. In particular, the output laser beams in the beam convergence region are collimated Gaussian beams or collimated Gaussian-like beams.

In particular, the output laser beams in the beam convergence region do not exist as converging beams. This means that a particular output laser beam does not have any converging beam portions and/or partial beams. In particular, a particular output laser beam is not focused into a point.

Each output laser beam is then associated in particular with a single Poynting vector with a unique orientation. The Poynting vectors then serve as a reference for specifying the first angle and/or the second angle between two adjacent output laser beams. In particular, in this case the Poynting vector of a particular output laser beam corresponds to its main propagation direction.

In particular, in the case of the output laser beams present as collimated beam bundles, the output laser beams converge towards one another in the beam convergence region to form the interference pattern, and the output laser beams adjacent to one another in the beam convergence region form a non-vanishing first angle associated with the first angular coordinate, and/or output laser beams adjacent to one another in the beam convergence region form a non-vanishing second angle associated with the second angular coordinate.

Alternatively, it is possible for the output laser beams in the beam convergence region to be present as divergent beam bundles and/or spherical waves and/or partial spherical waves. A partial spherical wave is a geometric sub-region and/or a section of a spherical wave.

Then, in particular each output laser beam is associated with a plurality of Poynting vectors, and a direction of the Poynting vectors can be different for different beam portions of a particular output laser beam. The Poynting vectors then serve as a reference for specifying the first angle and/or the second angle between beam portions of two adjacent output laser beams. A main propagation direction of a certain output laser beam then corresponds in particular to an averaged direction over all non-vanishing Poynting vectors of the output laser beam.

In the case of the output laser beams present as divergent beam bundles, these in particular have only beam portions which converge towards one another in the beam convergence region to form the interference pattern, and in the beam convergence region only beam portions of output laser beams adjacent to one another form a non-vanishing first angle associated with the first angular coordinate, and/or in the beam convergence region only beam portions of output laser beams adjacent to one another form a non-vanishing second angle associated with the second angular coordinate. In particular, the adjacent output laser beams in this case also have other beam portions which do not converge and/or which do not form the stated first angle and/or second angle.

The output laser beams are formed in particular by collimation and/or deflection of the amplified coherent laser beams. In particular, the deflection takes place in such a way that the output laser beams converge to form the interference pattern.

Amplified coherent laser beams coupled out of the amplification device and/or out of amplification elements of the amplification device are present in particular as divergent beam bundles and/or as spherical waves and/or partial spherical waves.

It may be advantageous if the laser system has a focusing device for collimating and/or deflecting amplified coherent laser beams incident on the focusing device. This makes it possible, for example, to collimate amplified coherent laser beams present as divergent beam bundles in order to provide the output laser beams in a collimated form.

The focusing device can basically have one or more focusing elements for collimating and/or deflecting the amplified coherent laser beams. For example, the focusing element is or comprises an F-theta lens.

In one exemplary embodiment, the focusing device comprises a focusing element and in particular a single focusing element, wherein a plurality of and in particular all existing amplified coherent laser beams are incident on the focusing element and the amplified coherent laser beams are collimated and deflected by means of the focusing element in order to provide the output laser beams. This allows the laser system to be designed compactly and with a reduced number of optical components.

In particular, the focusing element is used to convert a positional offset of amplified coherent laser beams incident on it into an angular offset.

For example, the adjacent amplified coherent laser beams incident on the focusing element are positioned with a positional offset with respect to a first spatial direction and/or with respect to a second spatial direction, wherein the second spatial direction is oriented transverse and in particular perpendicular to the first spatial direction. From this positional offset, an angular offset is then created between adjacent emerging laser beams by means of the focusing element. These emerging laser beams correspond in particular to the output laser beams. The angle and/or first angle and/or second angle between the output laser beams can thus be formed.

For example, the adjacent amplified coherent laser beams incident on the focusing element are positioned as a one-dimensional or two-dimensional array with respect to the first spatial direction and/or the second spatial direction.

In a further exemplary embodiment, the focusing device has a plurality of focusing elements, wherein a focusing element is associated with each amplified coherent laser beam and the amplified coherent laser beams are each collimated by means of the associated focusing element.

In particular, the amplified coherent beams incident on and emerging from the focusing element then have the same main propagation direction. The adjacent amplified coherent laser beams incident on and/or emerging from the focusing element have, for example, a positional offset with respect to the first spatial direction and/or the second spatial direction and are in particular positioned as an array with respect to the first spatial direction and/or the second spatial direction.

In order to deflect the amplified coherent laser beams emerging from the respective focusing elements, a beam deflection device can then be provided in particular in order to form the output laser beams converging in the beam convergence region.

In one variant, both the amplified coherent laser beams incident on the focusing elements and the laser beams emerging from them are positioned in a converging manner. For example, amplification elements of the amplification device and/or the focusing elements are then positioned in a circular and/or spherical manner. This means that no separate beam deflection device is required.

In particular, it is possible for the existing focusing elements and/or the amplified coherent laser beams incident on the existing focusing elements to be configured and arranged such that laser beams emerging from the focusing elements form the beam convergence region and correspond to the output laser beams. In particular, no further deflection and/or beam shaping of the laser beams emerging from the focusing elements takes place.

In particular, it is possible for the focusing elements and/or the amplified coherent laser beams incident on the focusing elements to be configured and arranged such that laser beams emerging from the focusing elements converge to form the interference pattern. In particular, no separate beam deflection device is then required. The emerging laser beams then form the beam convergence region and correspond to the output laser beams.

It is possible for the laser system to have a beam deflection device for deflecting the amplified coherent laser beams in order to form the output laser beams converging in the beam convergence region. The beam deflection device comprises, for example, a plurality of mirror elements which are configured and arranged to deflect the amplified coherent laser beams entering the beam deflection device.

In one variant, it is possible for the amplified coherent laser beams coupled out of the amplification device to be present as divergent beam bundles, wherein a main propagation direction of adjacent amplified coherent laser beams is oriented in parallel or transversely, and the amplified coherent laser beams corresponding to the output laser beams. By arranging the adjacent coherent laser beams transverse to each other, this variant makes it possible to increase the beam portions of the output laser beams which contribute to the formation of the interference pattern.

In particular, it is possible for the interference pattern to have at least one interference element for laser machining of the workpiece, which is repeated within the interference pattern and in particular repeated at regular distances and in particular at equal distances. This makes it possible, for example, to create regular and/or periodic structures on the workpiece.

The interference pattern can basically be one-dimensional, two-dimensional or three-dimensional. For example, the interference element is repeated in one, two or three spatial dimensions.

For example, the interference element is or comprises at least one focused point and/or at least one focused line, such as a pattern of points and/or lines. The at least one focused point and/or the at least one focused line are used for laser machining of the workpiece and in particular have an intensity above a threshold which is required to carry out the laser machining of the workpiece.

It may be advantageous if the interference element is repeated within the interference pattern at least 10 times and in particular at least 100 times and in particular at least 1000 times. This makes it possible to create large-area periodic structures on the workpiece in one or a few work steps.

In particular, it is possible for the phase adjustment device to be configured to adjust a phase difference between all existing coherent laser beams and in particular to adjust it separately. In particular, the phase adjustment device is configured to adjust a phase position of each of the coherent laser beams separately.

In particular, the phase adjustment device comprises a plurality of phase adjustment elements, and preferably each coherent laser beam is associated with a phase adjustment element. The phase position of a particular coherent laser beam can then be adjusted, for example, by means of the phase adjustment element associated with it.

It may be advantageous if at least one property of the interference pattern and/or of the interference element can be or is varied by adjusting and/or controlling the phase difference between the coherent laser beams by means of the phase adjustment device. This makes it possible, for example, to carry out dynamic machining of the workpiece. This also makes it technically easy to adapt the interference pattern to different applications.

The at least one property comprises in particular a distance between the interference elements and/or a periodicity of the interference elements and/or a peak intensity of the interference elements and/or an intensity profile of the interference elements and/or a geometric shape of the interference elements.

For example, it is possible, during operation of the laser system, for at least a subset of the interference elements of the interference pattern to be moved relative to the workpiece and/or scanned over the workpiece by controlling and in particular exclusively by controlling the phase difference between the coherent laser beams.

In particular, it is possible for the interference pattern to extend with respect to at least one spatial direction over an extension length of at least 0.5 mm and preferably at least 1 mm and preferably at least 2 mm. For example, the interference pattern extends in at least one spatial direction over an extension length of at most 10 mm.

In particular, the interference pattern is homogeneous or approximately homogeneous over the extension length with regard to its properties, such as peak intensity and/or an intensity profile and/or a geometric shape of interference elements of the interference pattern.

In particular, the interference pattern is temporally static (with temporally static parameters with respect to the phase difference between the coherent laser beams). In particular, the interference pattern is fully formed with respect to its extension length at a certain point in time. In particular, all existing interference elements of the interference pattern are present simultaneously.

It may be advantageous if the amplification device is arranged downstream of the phase adjustment device with respect to a main propagation direction of the coherent laser beams. In particular, the phase difference between the coherent laser beams can be adjusted by means of the phase adjustment device at a reduced power (compared to a power of the amplified coherent laser beams). This allows a technically simpler implementation of the phase adjustment device.

However, as an alternative, it is also possible in principle for the phase adjustment device to be arranged downstream of the amplification device.

It may be advantageous if the amplification device has a plurality of amplification elements for amplifying a coherent laser beam, and in particular characterized in that the amplification elements are rod-like and/or designed as fiber amplifiers. The amplification elements can be arranged in particular in a geometrically flexible manner. For example, they can be arranged as an array. This enables geometrically flexible and simple positioning and orientation of the amplified coherent laser beams coupled out of the amplification elements.

In particular, an amplification element is associated with a specific coherent laser beam. In particular, a main propagation direction of the amplified coherent laser beam coupled out of the amplification element is oriented parallel to a preferred direction and/or longitudinal center axis of the amplification element.

In particular, it is possible for the amplification device to be designed to adjust an output power of the amplified coherent laser beams and in particular to adjust the output power for each amplified coherent laser beam separately. For example, the output power of a particular amplified coherent laser beam can be adjusted by means of an amplification element associated with that amplified coherent laser beam.

Preferably, the output power can then be controlled from zero to a maximum value. By selecting an output power of zero, the corresponding amplified coherent laser beam and in particular the output laser beam formed from it can be deactivated so that they no longer contribute to the formation of the interference pattern.

It may be advantageous if the laser system has a splitting device for splitting an input laser beam provided by the laser beam source into several coherent laser beams. This makes it possible, for example, to provide the existing coherent laser beams using a single laser beam source.

In principle, it is also possible for the laser system to have a plurality of laser beam sources, with one or more coherent laser beams being provided by means of one laser beam source.

In particular, it is possible for the laser system to have a feed device for adjusting a position and/or orientation of the workpiece relative to the interference pattern. In particular, the feed device is configured to carry out a movement of the workpiece relative to the interference pattern.

In particular, the workpiece can be arranged and/or fixed to a workpiece holder of the laser system in order to carry out the laser machining.

The laser beam source provides in particular pulsed laser radiation and in particular ultrashort pulse laser radiation. In particular, the input laser beam provided by the laser beam source and/or the coherent laser beams and/or the amplified coherent laser beams and/or the output laser beams are pulsed laser beams and in particular ultrashort pulse laser beams.

According to embodiments of the invention, in the method mentioned at the outset, a plurality of coherent laser beams are provided by means of at least one laser beam source, amplified coherent laser beams are formed by amplifying the coherent laser beams by means of an amplification device, and a phase difference between the coherent laser beams is adjusted by means of a phase adjustment device, and output laser beams based on the amplified coherent laser beams or corresponding to the amplified coherent laser beams are formed and converge in a beam convergence region to form the interference pattern, wherein at least beam portions of different output laser beams converge in the beam convergence region.

The method according to embodiments of the invention in particular has one or more features and/or advantages of the laser system according to embodiments of the invention. Advantageous embodiments have already been explained in connection with the laser system.

The method according to the embodiments of the invention can be carried out in particular by means of the laser system according to embodiments of the invention. In particular, the method according to the embodiments of the invention is carried out by means of the laser system according to embodiments of the invention.

The fact that a first device and/or a first element of the machining system is arranged downstream of a second device and/or a second element of the laser system is to be understood in the present case as meaning that the laser beams guided in the laser system, such as the input laser beam and/or the coherent laser beams and/or the amplified coherent laser beams, first impinge on the second device and/or the second element and then on the first device and/or the first element. Then, the second device and/or the second element is arranged upstream of the first device and/or the first element. These specifications must always be in relation to the main propagation direction of the laser beams.

Elements that are the same or have equivalent functions are provided with the same reference signs in all of the figures.

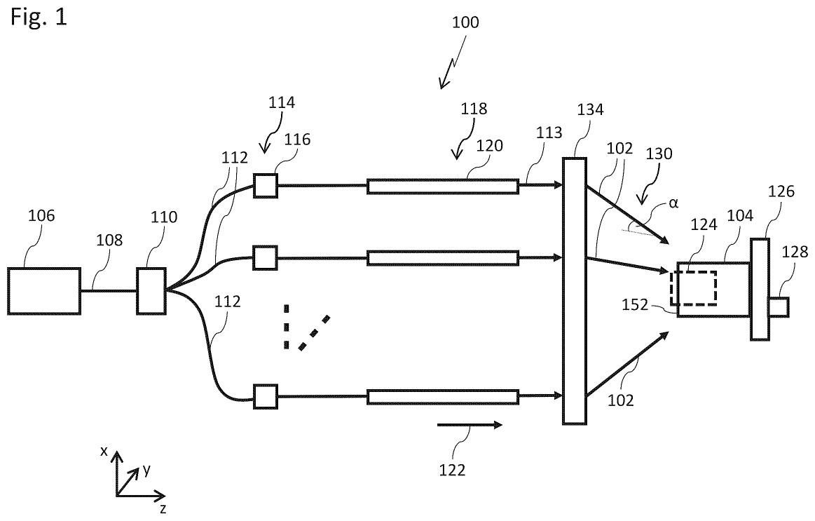

An exemplary embodiment of a laser system is shown schematically in FIGS. 1, 2 and 3, and is denoted therein by 100. During operation of the laser system 100, a plurality of output laser beams 102 are provided which form an interference pattern intended for laser machining of a workpiece 104. The resulting interference pattern is based in particular on the principle of direct laser interference patterning (DLIP).

In the exemplary embodiment shown, the laser system 100 comprises a laser beam source 106 by means of which an input laser beam 108 is provided, wherein the input laser beam 108 is split into a plurality of coherent laser beams 112 by means of a splitting device 110.

The laser beams provided by the laser beam source 106, such as the input laser beam 108 and/or the coherent laser beams 112, are, for example, linearly polarized laser beams. In particular, these laser beams have a high beam quality, wherein a beam quality factor and/or M² value is less than 1.5.

In particular, each of the coherent laser beams 112 has an average power in the range of 10 W and 500 W.

In particular, the laser beams provided by the laser beam source 106 are pulsed laser beams, and laser pulses of these laser beams preferably have a pulse duration between 10 ps and 1000 ps and/or a repetition rate between 100 kHz and 1 MHz.

The splitting device 110 can, for example, be implemented using fiber optics and/or comprise at least one fiber-optic beam splitter. A fiber-optic beam splitter comprises, for example, an input waveguide, to which further waveguides for beam splitting are connected on the output side and are connected in particular by splicing.

In principle, it is also possible for there to be a plurality of laser beam sources 106 for providing the coherent laser beams 112. For example, one or more coherent laser beams 112 are then provided by means of a laser beam source 106.

The coherent laser beams 112 coupled out of the splitting device 110 are preferably guided in optical waveguides and/or optical fibers, and the coherent laser beams 112 can, for example, each be guided in single-core waveguides, as indicated in FIG. 1. In principle, it is also possible to provide multi-core waveguides to guide the coherent laser beams 112.

To adjust a phase difference between the individual coherent laser beams 112, a phase adjustment device 114 is provided, which preferably comprises a plurality of phase adjustment elements 116. A specific phase adjustment element 116 can be used to adjust a phase of a coherent laser beam 112 associated therewith.

For example, a plurality or all of the coherent laser beams 112 are associated with a phase adjustment element 116. In the case of N coherent laser beams 112, the phase adjustment device 114 comprises, for example, N−1 or N phase adjustment elements 116. In particular, this makes it possible to adjust a phase difference between all existing coherent laser beams 112.

The phase adjustment device 114 and/or the phase adjustment elements 116 can, for example, be integrated into optical waveguides in which the coherent laser beams 112 are guided.

To amplify the coherent laser beams 112, the laser system 100 comprises an amplification device 118, which preferably comprises a plurality of amplification elements 120. For example, an amplification element 120 is associated with a specific coherent laser beam 112. Amplified coherent laser beams 113 are formed by amplifying the coherent laser beams 112 by means of the amplification device 118.

In relation to a main propagation direction 122, the amplification device 118 or the amplification elements 120 are arranged downstream of the phase adjustment device 114 or the phase adjustment elements 116, i.e., the coherent laser beams 112 pass through the phase adjustment elements 116 first and then the amplification elements 120.

The main propagation direction 122 is understood to mean a main direction and/or mean direction of the input laser beam 108 or the coherent laser beams 112 or the amplified coherent laser beams 113 or the output laser beams 102 in which they propagate through the laser system 100. In particular, the main propagation direction 122 corresponds to a main direction and/or mean direction of Poynting vectors associated with the corresponding laser beam.

For example, coherent laser beams 112 coupled out of the phase adjustment device 114 are coupled into the amplification device 118. In particular, the phase differences between the coherent laser beams 112 are adjusted by means of the phase adjustment device 114 before they are coupled into the amplification device 118.

The amplification elements 118 can in particular be arranged and/or oriented separately and/or spatially separated from one another. The amplification elements 120 are, for example, rod-like and/or designed as fiber amplifiers. For example, the amplification elements 120 are or include “rod-type photonic crystal fiber amplifiers”, as known, for example, from J. Limpert et al., “High-power rod-type photonic crystal fiber laser,” Opt. Express 13, 1055-1058 (2005).

It is also possible for the amplification device 118 and/or the amplification elements 120 to be designed as multi-core waveguides and/or are integrated into a multi-core waveguide. The individual coherent laser beams 112 and/or amplified coherent laser beams 113 are then separated from one another, in particular in the far field.

All existing amplification elements 120 are advantageously designed in the same way and/or as identical parts.

The output laser beams 102 of the laser system 100 are those coherent laser beams which are amplified by the amplification device 118 during operation of the laser system 100 and are designed and/or configured such that they form an interference pattern 124 intended for laser machining of the workpiece 104. The output laser beams 102 are therefore the laser beams contributing to and/or configured to form the interference pattern 124.

The output laser beams 102 converge towards the interference pattern 124 and/or come from different directions. The output laser beams 102 run in particular in a beam convergence region 130 of the laser system 100 associated with the interference pattern 124 or form a beam convergence region 130 of the laser system 100 associated with the interference pattern 124.

The output laser beams 102 are therefore the laser beams contributing to the formation of the interference pattern 124. Depending on the embodiment, the output laser beams 102 are based on or correspond to the coherent laser beams 113 amplified by the amplification device 118.

The interference pattern 124 formed by means of the provided output laser beams 102 extends, for example, in a plane or in a three-dimensional volume.

The interference pattern 124 formed is applied to the workpiece 104 for laser machining. The laser system 100 can have a workpiece holder 126 on which the workpiece 104 can be arranged and/or fixed in order to apply the interference pattern 124 to it.

Furthermore, the laser system 100 can have a feed device 128 which is configured to adjust a position and/or orientation of the workpiece 104 relative to the interference pattern 124 and/or which is configured to carry out a movement of the workpiece 104 relative to the interference pattern 124. For example, the feed device 128 is configured to move the workpiece holder 126 and the workpiece 104 arranged thereon relative to the interference pattern 124 and in particular to move it along a predetermined trajectory.

In order to form the interference pattern 124, it is necessary that the output laser beams 102 contributing to its formation are oriented so as to converge with one another and have a non-vanishing angle with respect to one another. More specifically, the main propagation directions 122 and/or Poynting vectors 132 of the adjacent output laser beams 102 have a non-vanishing angle with respect to one another.

In a first variant of the laser system 100, all existing output laser beams 102 are arranged in a common plane or surface (see, for example, the three output laser beams 102 shown in FIG. 1), with output laser beams 102 adjacent to one another forming a non-vanishing first angle α with respect to one another and each converging at this first angle α, i.e., adjacent output laser beams 102 converge in the direction of the interference pattern 124 to be formed at the first angle α.

The first angle α extends in particular in a first direction and/or with respect to a first angular coordinate.

The interference pattern 124 resulting in this case extends two-dimensionally in the stated common plane of the output laser beams 102 and in particular exclusively in this plane (the z-x plane in the example shown in FIG. 1).

In the example according to FIG. 1, the first variant is realized in that the amplified coherent laser beams 113 emerging from the amplification elements 120 are positioned at a distance from one another in the first spatial direction x and are coupled into a focusing device 134 of the laser system 100. The focusing device 134 has one or more focusing elements 136, each of which comprises a focusing optical unit and/or an F-theta lens or is designed as such. The amplified coherent laser beams 113 incident on the focusing device 134 run, for example, parallel to one another and/or in a plane parallel to the first spatial direction x. For example, the amplification elements 120 and/or the amplified coherent laser beams 113 emerging from them are arranged as an array with respect to the first spatial direction x.

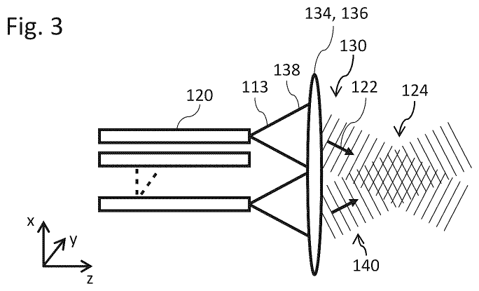

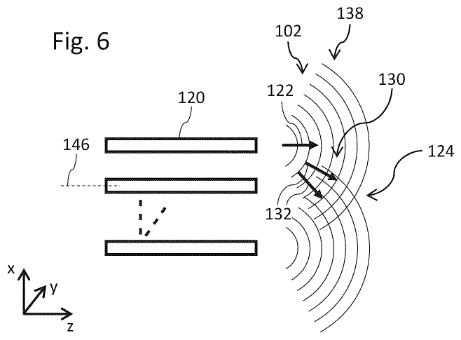

The amplified coherent laser beams 113 emerge in particular as a divergent beam bundle 138 and/or as spherical waves or at least as sub-regions of spherical waves from the amplification elements 120 (e.g., indicated in FIG. 6) and are incident in this form on the focusing device 134. The focusing device 134 is designed to collimate the amplified coherent laser beams 113 incident thereon. The output laser beams 102, each formed from an amplified coherent laser beam 113 incident on the focusing device 134, each emerge from the focusing device 134 as a collimated beam bundle 140 and/or as plane waves (e.g., indicated in FIG. 3).

In the example shown in FIGS. 1, 2 and 3, a single focusing element 136 is associated with all existing amplified coherent laser beams 113. Adjacent amplified coherent laser beams 113 impinge on the focusing element 136 with a positional offset with respect to the first spatial direction x, and the positional offset downstream of the focusing element 136 results in an angular offset between the output laser beams 102, formed from the amplified coherent laser beams 113, in the form of the stated first angle α between adjacent output laser beams 102.

The positional offset of the amplified coherent laser beams 113 or the resulting first angle α can be the same for all or for a subset of the amplified coherent laser beams 113 or output laser beams 102. However, it is also possible for the positional offset or first angle α between different adjacent amplified coherent laser beams 113 or output laser beams 102 to be selected differently.

In a second variant, there is a plurality of planes or surfaces in which the existing output laser beams 102 run, and in particular different subsets of output laser beams 102 are associated with different planes. The output laser beams 102 associated with a specific subset then run in the same plane or surface.

In the example according to FIGS. 1, 2 and 3, the second variant can be realized in that there are both amplified coherent laser beams 113 spaced apart from one another in the first spatial direction x as well as amplified coherent laser beams 113 which are spaced apart from one another in a second spatial direction y oriented transverse and in particular perpendicular to the first spatial direction x. For example, the amplification elements 120 and/or the amplified coherent laser beams 113 emerging from them are arranged as a two-dimensional array with respect to the first spatial direction x and the second spatial direction y.

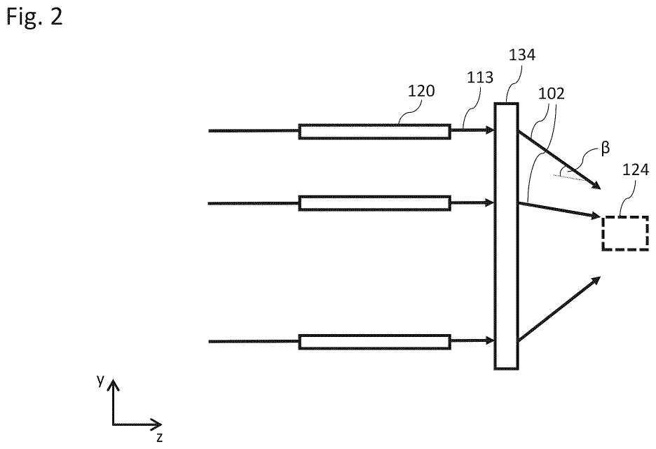

There are then both adjacent output laser beams 102 which have a non-vanishing first angle α with respect to one another and each converge at this first angle α (FIG. 1) as well as adjacent output laser beams 102 which have a non-vanishing second angle β with respect to one another and each converge at this second angle β (FIG. 2).

The second angle β extends in particular in a second direction and/or with respect to a second angular coordinate (relative to a specific output laser beam 102 from which the first angle α or second angle β is measured in relation to the adjacent output laser beams 102). This second direction or second angular coordinate is different from the first direction or first angular coordinate of the first angle α. In particular, the first direction is oriented transverse or perpendicular to the second direction.

When describing the orientation of the output laser beams 102 in spherical coordinates, the first angle α corresponds, for example, to the polar angle and the second angle β corresponds to the azimuth angle.

The interference pattern 124 formed in the case of the second variant extends three-dimensionally in space (in all three spatial directions x, y and z in the example shown in FIG. 1).

The output laser beams 102 converging in the beam convergence region 130 are thus realized in the variants described above by means of the positional offset of the amplified coherent laser beams 113 incident on the focusing element 136 and the resulting angular offset in the form of the first angle α and/or the second angle β.

To form the interference pattern 124, the angular offset between adjacent output laser beams must be within a certain range. The theoretically possible range in which the formation of the interference pattern 124 can occur is between 2° and 180°. Preferably, the first angle α and/or the second angle β have values between 15° and 25°.

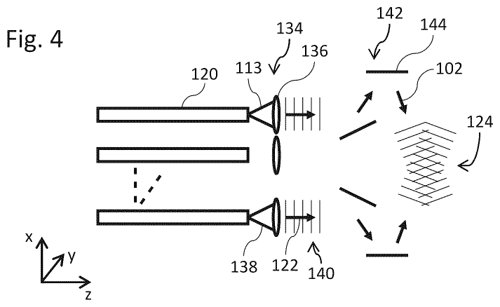

The example shown in FIG. 4 differs from the examples described above in that the focusing device 134 comprises a plurality of focusing elements 136 and that the laser system 100 has a beam deflection device 142 to form the angular offset between the output laser beams 102. Otherwise, this example has the same structure and/or functionality as the examples described above.

In the example shown, each of the amplification elements 120 and/or each of the amplified coherent laser beams 113 emerging from the amplification elements 120 is associated with a focusing element 136 and in particular a single focusing element 136.

The amplified coherent laser beams 113 emerge from the associated amplification elements 120 as divergent beam bundles 138 and are converted into collimated beam bundles 140 by means of the focusing elements 136. The amplified coherent laser beams 113 emerging from the respective focusing elements 136 are, for example, oriented parallel to one another.

Thus, in this example, the focusing device 134 and/or the focusing elements 136 cause a collimation of the amplified coherent laser beams 113 and in particular no focusing thereof.

To form the output laser beams 102 which converge in the beam convergence region 130 and form the interference pattern 124, the amplified coherent laser beams 113 emerging from the focusing elements 136 are coupled into the beam deflection device 142. This is configured to form the output laser beams 102 with the angular offset described above from the coupled-in amplified coherent laser beams 113. The adjacent output laser beams 102 are then oriented so as to be convergent with one another and each have the non-vanishing first angle α and/or second angle β with respect to one another.

The beam deflection device 142 can, for example, have a plurality of mirror elements 144 which are configured and arranged such that the converging output laser beams 102 are formed from the coupled-in amplified coherent laser beams 113, which are, for example, oriented parallel to one another.

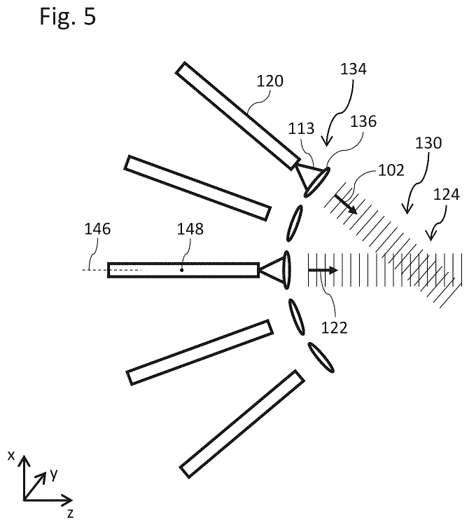

In the example shown in FIG. 5, the focusing device 134, analogous to the exemplary embodiment according to FIG. 4, has a plurality of focusing elements 136, a specific focusing element 136 causing a collimation of the amplified coherent laser beam 113 associated therewith. For example, each amplification element 120 is associated with a focusing element 136.

The focusing elements 136 and/or the amplified coherent laser beams 113 impinging on the focusing elements 136 are configured and arranged such that the laser beams emerging from the focusing elements 136 already run convergently with respect to one another and have the described angular offset with respect to one another in order to form the interference pattern 124. These emerging laser beams thus correspond to the output laser beams 102 or have the described properties of the output laser beams 102.

For example, the amplification elements 120 are arranged and/or configured such that the coherent laser beams 120 coupled out of them and impinging on the focusing elements 136 already have the stated angular offset in the form of the first angle α and/or the second angle β. Therefore, in this example, the output laser beams 102 coupled out of the focusing elements 136 have the angular offset from one another in order to form the interference pattern 124.

The amplification elements 120 are, for example, rod-like and/or designed as “rod-type photonic crystal fiber amplifiers”, and the main propagation direction 122 of the amplified coherent laser beam 113 emerging from a specific amplification element 120 is parallel or at least approximately parallel to a longitudinal center axis 146 of the amplification element 120. For example, the longitudinal center axes 146 of adjacent amplification elements 120 are then oriented with respect to one another with the angular offset in the form of the first angle α and/or the second angle β. Centers of the amplification elements 120 are positioned, for example, in a circular and/or spherical manner.

In the above-described exemplary embodiments according to FIGS. 1 to 5, the output laser beams 102 are each present as collimated beam bundles 140 and/or in the form of plane waves. In this case, the output laser beams 102 are each associated exactly with one Poynting vector 132, which corresponds to the main propagation direction 122. In this case, the Poynting vector 132 is a globally uniform property of the collimated output laser beam 102.

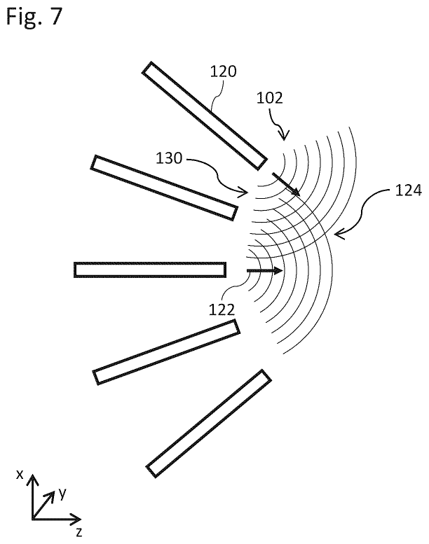

In the exemplary embodiments of the laser system 100 shown in FIGS. 6 and 7, the output laser beams 102 provided for forming the interference pattern 124 are provided in the form of divergent beam bundles 138 and/or spherical waves. In this case, the Poynting vector 132 is always oriented perpendicular to the orientation of the wavefront of the spherical waves of a specific output laser beam 102 and is thus oriented locally differently (indicated in FIG. 6). The non-vanishing Poynting vectors 132 associated with a specific output laser beam 102 thus cover a specific angular range. The main propagation direction 122 of the output laser beam 102 is then understood to be an averaged direction over all non-vanishing Poynting vectors 132.

The amplification elements 120 are arranged and/or configured such that at least beam portions of adjacent laser beams coupled out of them have Poynting vectors 132 with an angular offset in the form of the first angle α and/or the second angle β.

For example, the amplification elements 120 are arranged and/or configured such that the output laser beams 102 coupled out of them and impinging on the focusing elements 136 already have the aforementioned angular offset in the form of the first angle α and/or the second angle β. Accordingly, in this example, the beam portions of the output laser beams 102 coupled out of the focusing elements 136 have the appropriate angular offset from one another in order to form the interference pattern 124. In this case, these laser beams emerging from the amplification elements 120 thus correspond to the output laser beams 102 or at least partially have the necessary properties for forming the interference pattern 124.

In particular, in the exemplary embodiments according to FIGS. 6 and 7, no focusing device 134 and/or no focusing elements 136 are provided for collimating the laser beams emerging from the amplification elements 120.

In the example shown in FIG. 6, the longitudinal center axes 146 of the amplification elements 120 and/or the main propagation directions 122 of adjacent output laser beams 102 are oriented in parallel or at least approximately in parallel. In order to enlarge the respective beam portions of adjacent output laser beams 102 which have a suitable angular offset in the form of the first angle α and/or the second angle β in order to form the interference pattern 124, it is possible for the respective main propagation directions 122 of the adjacent output laser beams 102 to be angled so as to converge towards one another (FIG. 7). The main propagation directions 122 of the adjacent output laser beams 102 then have a non-vanishing first angle α and/or second angle β with respect to one another, which can be, for example, between 1° and 180°.

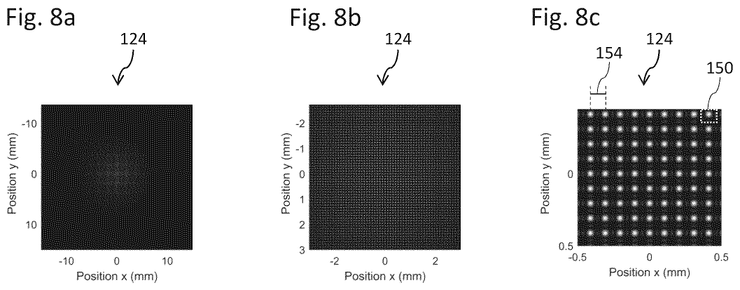

A first example of an interference pattern 124 formed by the laser system 100 is shown in FIGS. 8a, 8b and 8c as a grayscale representation at different scales, with lighter gray values representing higher intensities. The interference pattern 124 has an interference element 150 which repeats several times in at least one spatial direction x, y, z, the repeating interference elements 150 being spaced apart from one another in this at least one spatial direction and in particular being arranged adjacent to one another at the same distance from one another. In the example shown in FIGS. 8a to 8c, the interference element 150 is designed as a single point and/or focal point.

For example, the interference element 150 repeats itself two-dimensionally in the first spatial direction x and in the second spatial direction y or as a three-dimensional volume in all three spatial directions. The interference element 150 in particular forms the interference pattern 124.

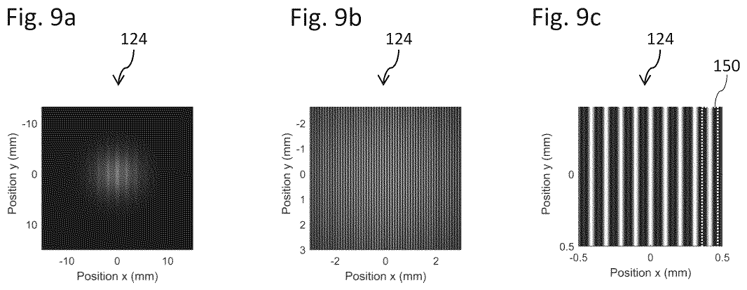

In the example shown in FIGS. 9a to 9c, the interference element 150 is formed in a stripe-lie manner and/or as a single focused stripe.

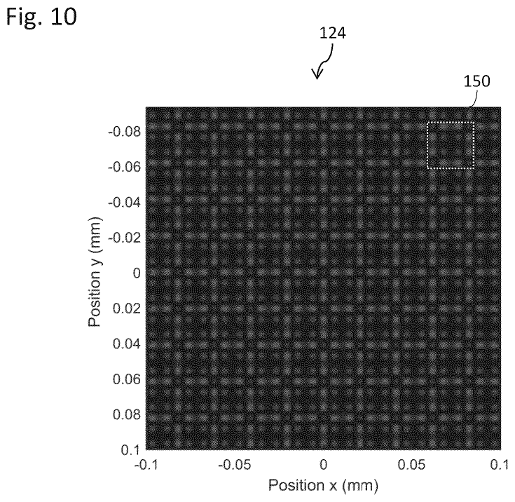

In the example shown in FIG. 10, the interference element 150 consists of a point pattern and/or a plurality of focused points.

The laser system 100 functions as follows: during operation of the laser system 100, the interference pattern 124 is formed by means of the output laser beams 102 and the interference pattern 124 is applied to the workpiece 124 arranged on the workpiece holder 126 in order to carry out the laser machining.

A typical application may, for example, consist of performing a large-area machining of the workpiece 104 on an outer side 152 of the workpiece 104 and/or in the region of an outer side 152 of the workpiece 104. For example, periodic structures with predetermined properties can be created on the outer side 152 using the interference pattern 124.

It is possible for the workpiece 124 to be positioned and/or oriented relative to the interference pattern 124 by means of the feed device 128 in order to carry out the laser machining, and/or to be moved relative to the interference pattern 124.

By changing the phase differences between the coherent laser beams 112 by means of the phase adjustment elements 116, the phase differences between the amplified coherent laser beams 113 and/or between the output laser beams 102 can be changed accordingly. This makes it possible to adapt properties of the interference pattern 124 and/or the interference elements 150 of the interference pattern 124.

During operation of the laser system 100, a distance 154 between adjacent interference elements 150 can be adjusted, for example, by varying the phase differences using the phase adjustment elements 116. Furthermore, for example, a periodicity of the interference elements 150 can be adjusted, such as a regularity of the positioning of the interference elements 150. In addition, for example, an intensity profile and/or a geometric shape of the interference elements 150 can be adapted. For example, the interference elements 150 and/or selected interference elements 150 can be scanned across the workpiece 104 by controlling the phase differences and in particular exclusively by controlling the phase differences by means of the phase adjustment elements 116.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

α First angle
β Second angle
X First spatial direction
y Second spatial direction
100 Laser system
102 Output laser beam
104 Workpiece
106 Laser beam source
108 Input laser beam
110 Splitting device
112 Coherent laser beam
113 Amplified coherent laser beam
114 Phase adjustment device
116 Phase adjustment element
118 Amplification device
120 Amplification element
122 Main propagation direction
124 Interference pattern
126 Workpiece holder
128 Feed device
130 Beam convergence region
132 Poynting vector
134 Focusing device
136 Focusing element
138 Divergent beam bundle
140 Collimated beam bundle
142 Beam deflection device
144 Mirror element
146 Longitudinal center axis
148 Center
150 Interference element
152 Outer side
154 Distance

1. A laser system for laser machining a workpiece using an interference pattern, the laser system comprising:
at least one laser beam source for providing a plurality of coherent laser beams,
an amplification device for forming amplified coherent laser beams by amplifying the plurality of coherent laser beams,
a phase adjustment device for adjusting a phase difference between the plurality of coherent laser beams and/or the amplified coherent laser beams, and
a beam convergence region in which output laser beams based on the amplified coherent laser beams or corresponding to the amplified coherent laser beams converge to form the interference pattern, wherein at least beam portions of the different output laser beams converge in the beam convergence region.

2. The laser system according to claim 1, wherein adjacent output laser beams present in the beam convergence region have at least beam portions which form an angle of at least 0.2° and/or at most 40°.

3. The laser system according to claim 1, wherein, in the beam convergence region, adjacent output laser beams have beam portions which form a non-vanishing first angle associated with a first angular coordinate, wherein the first angle is at least 0.2° and/or at most 40°.

4. The laser system according to claim 3, wherein, in the beam convergence region, adjacent output laser beams have beam portions which form a non-vanishing second angle associated with a second angular coordinate different from the first angular coordinate, wherein the second angle is at least 0.2° and/or at most 40°.

5. The laser system according to claim 4, wherein adjacent output laser beams present in the beam convergence region are oriented with respect to one another in such a way that two adjacent output laser beams have either beam portions which form the non-vanishing first angle or beam portions which form the non-vanishing second angle.

6. The laser system according to claim 1, wherein the output laser beams in the beam convergence region are present as collimated beam bundles, or the output laser beams in the beam convergence region are present as divergent beam bundles.

7. The laser system according to claim 1, further comprising a focusing device for collimating and/or deflecting the amplified coherent laser beams incident on the focusing device.

8. The laser system according to claim 7, wherein the focusing device comprises a focusing element, wherein the amplified coherent laser beams are incident on the focusing element, and wherein the amplified coherent laser beams are collimated and deflected by the focusing element in order to provide the output laser beams.

9. The laser system according to claim 7, wherein the focusing device comprises a plurality of focusing elements, wherein each respective focusing element is associated with each respective amplified coherent laser beam, and wherein each respective amplified coherent laser beam is collimated by the respective focusing element.

10. The laser system according to claim 7, wherein focusing elements of the focusing device and/or the amplified coherent laser beams incident on the focusing elements are configured and arranged such that laser beams emerging from the focusing elements form the beam convergence region and correspond to the output laser beams.

11. The laser system according to claim 1, further comprising a beam deflection device for deflecting the amplified coherent laser beams in order to form the output laser beams converging in the beam convergence region.

12. The laser system according to claim 1, wherein the amplified coherent laser beams coupled out of the amplification device are present as divergent beam bundles, wherein a main propagation direction of adjacent amplified coherent laser beams is oriented in parallel or transversely, and wherein the amplified coherent laser beams correspond to the output laser beams.

13. The laser system according to claim 1, wherein the interference pattern has at least one interference element for laser machining of the workpiece, wherein the at least one interference element is repeated within the interference pattern.

14. The laser system according to claim 13, wherein the interference element is repeated within the interference pattern at least 10 times.

15. The laser system according to claim 13, wherein, by adjusting the phase difference between the coherent laser beams or the amplified coherent laser beams using the phase adjustment device, at least one property of the interference pattern and/or of the interference element is varied, wherein the at least one property comprises a distance between the interference elements, and/or a periodicity of the interference elements, and/or a peak intensity of the interference elements, and/or an intensity profile of the interference elements, and/or a geometric shape of the interference elements.

16. The laser system according to claim 1, wherein the amplification device comprises a plurality of amplification elements, each respective amplification element for amplifying a respective coherent laser beam.

17. A method for laser machining a workpiece using an interference pattern, the method comprising:
providing a plurality of coherent laser beams by using at least one laser beam source,
amplifying the plurality of coherent laser beams to form amplified coherent laser beams by using an amplification device,
adjusting a phase difference between the plurality of coherent laser beams and/or the amplified coherent laser beams by using a phase adjustment device, and
forming output laser beams based on the amplified coherent laser beams or corresponding to the amplified coherent laser beams, wherein the output laser beams converge in a beam convergence region to form the interference pattern, and wherein at least beam portions of the different output laser beams converge in the beam convergence region.
